(19) United States
(12) Patent Application Publication
(10) Pub. No.: US 2015/0343852 A1
(43) Pub. Date: Dec. 3, 2015

(54) Pneumatic Tire

(71) Applicant: (THE YOKOHAMA RUBBER CO., LTD.,), Minato-ku, Tokyo (JP)

(72) Inventor: Ayako Joza, Hiratsuka-shi, Kanagawa (JP)

(21) Appl. No.: 14/759,921

(22) PCT Filed: Dec. 26, 2013
(86) PCT No.: PCT/JP2013/084909

§ 371 Date: Jul. 8, 2015

(30) Foreign Application Priority Data
Jan. 10, 2013 (JP) 2013-002790

(51) Int. Cl. B60C 11/24; B60C 11/13

(52) U.S. Cl. CPC B60C 11/24; B60C 11/1307; B60C 2011/133

(57) ABSTRACT

A pneumatic tire having grooves on a tread surface, wherein recessed sections are provided on groove wall surfaces of the grooves, and a photoluminescent material is adhered to the inside of the recessed sections.

### TECHNICAL FIELD

The present technology pertains to a pneumatic tire. More specifically, the present technology pertains to a pneumatic tire enabling a degree of wear to be easily and accurately recognized.

### BACKGROUND ART

A conventional tire is disclosed, for example in Japanese Unexamined Patent Application Publication No. H8-258517A that clearly makes a notification of an exchange period for a worn tire, using a groove bottom of a drainage groove of a ground contact patch of a tire and a slip sign disposed on the drainage groove bottom that are color-coded by paint or by fluorescent paint in whole or in part, for easy viewing.

Furthermore, Japanese Unexamined Patent Application Publication No. 2004-203318A discloses a tire that has a tread wear indicator disposed on a groove bottom section of a groove disposed in a tread section. The tread wear indicator includes a surface rubber layer disposed on the surface layer and a different colored rubber layer disposed on the inner side of the surface rubber layer in the radial direction. The surface rubber layer is disposed continuously on the surface layer of the groove bottom section and made from the same rubber material as that forming the groove bottom section, and the different colored rubber layer has a color different from that of the surface rubber layer and that of a rubber section adjacent to the inside of the different colored rubber layer in the radial direction.

Furthermore, Japanese Utility Model No. 3130375 discloses a tire in which a slip sign is made of a rubber column having three colors of blue, light blue, and red and is embedded into a ground contact patch, such that the wear of the tire is identifiable.

Furthermore, Japanese Unexamined Patent Application Publication No. 2006-232152A discloses a tire having a degree of wear indicator that directly indicates a degree of wear by changing in appearance according to the degree of wear of a tread provided in the tread road contact surface. The degree of wear indicator is provided as a plurality of recessed sections varying in depth, each separately disposed in a predetermined row direction in depth order.

The tires disclosed in Japanese Unexamined Patent Application Publication Nos. H8-258517A and 2004-203318A, described above, make a notification of an exchange period by having a slip sign or a tread wear indicator become worn. Conversely, the tires disclosed in Japanese Utility Model No. 3130375 and Japanese Unexamined Patent Application Publication No. 2006-232152A, described above, indicate a degree of wear. However, the tires disclosed in Japanese Utility Model No. 3130375 and Japanese Unexamined Patent Application Publication No. 2006-232152A provide a portion indicating the degree of wear on a road contact surface of a tread. In Japanese Utility Model No. 3130375, a rubber column of a different material than the tread is used. In Japanese Unexamined Patent Application Publication No. 2006-232152A, a recessed section is used. As such, there is a risk of impairing tire performance due to uneven wear of the road contact surface, deterioration in driving stability, and the like.

### SUMMARY

The present technology provides a pneumatic tire enabling a degree of wear to be easily and accurately recognized without impairing tire performance.

A pneumatic tire according to a first aspect of the technology is a pneumatic tire with a groove in a tread surface, the pneumatic tire including a recessed section provided in a groove wall surface of the groove, and a photoluminescent material adhered to the inside of the recessed section.

According to this pneumatic tire, the photoluminescent material adheres to the groove wall surface of the groove. Thus, a degree of wear of the tread surface is recognizable by the photoluminescent material decreasing or disappearing due to wear of the tread surface. Furthermore, according to this pneumatic tire, the photoluminescent material adheres to the inside of the recessed section. Thus, even when a stone or the like enters the groove, contact with the photoluminescent material is prevented. As such, the photoluminescent material may be prevented from falling out, which in turn enables improvements to anti-abrasion characteristics and anti-weathering characteristics of the photoluminescent material. Therefore, the photoluminescence of the photoluminescent material may be maintained while the degree of wear of the tread surface may be easily and accurately recognized.

Furthermore, the pneumatic tire according to the first aspect of the technology has a step formed in the groove wall surface of the groove in a tire circumferential direction, has a recessed section provided at least in a top surface forming the step, and has a photoluminescent material adhered to the inside of the recessed section in a second aspect of the technology.

According to this pneumatic tire, having the photoluminescent material adhered to the inside of the recessed section provided at least in the top surface of the step enables the visibility of the tread surface to be improved in a plan view, thereby enabling the degree of wear of the tread surface to be easily and accurately recognized.

Furthermore, the pneumatic tire according to the second aspect of the technology has the step provided in plurality in the tire radial direction, has the recessed section provided at least in the top surface of each of the steps, and has the photoluminescent material adhered to the inside of the recessed section in a third aspect of the technology.

According to this pneumatic tire, having the photoluminescent material adhered to the inside of the recessed section provided at least in the top surface of each of a plurality of steps enables the visibility of the tread surface to be improved in a plan view, thereby enabling a degree of wear of the tread surface to be easily and accurately recognized and further enabling the degree of wear of the tread surface to be gradually recognized.

In addition, the pneumatic tire according to any one of the first to third aspects of the technology has a ratio of a major axis H1 of the photoluminescent material to a width H of a bottom surface of the recessed section such that 0.3≦H1/H≦0.95 in a fourth aspect of the technology.

According to this pneumatic tire, the visibility of the photoluminescent material may be enhanced by having H1/H to be at least 0.3. Furthermore, having H1/H to be no more than 0.95 enables the photoluminescent material to fit well into the recessed section and prevents the photoluminescent material from falling out.

Furthermore, the pneumatic tire of any one of the first to fourth aspects of the technology has a depth D of the recessed section such that 0.2 mm≦D≦1.5 mm in a fifth aspect of the technology.

According to this pneumatic tire, having the depth D of the recessed section to be at least 0.2 mm enables the photoluminescent material to fit well into the recessed section and prevents the photoluminescent material from falling out. Furthermore, having the depth D of the recessed section to be no more than 1.5 mm enables the visibility of the photoluminescent material to be improved.

Furthermore, the pneumatic tire according to any one of the first to fifth aspects of the technology has a small projection projecting within the recessed section provided on an inner side surface, closer to an opening side than to the bottom surface of the recessed section in a sixth aspect of the technology.

According to this pneumatic tire, the photoluminescent material adheres to the bottom surface of the recessed section engages with the small projection, thus preventing the photoluminescent material from falling out.

A pneumatic tire according to the present technology enables a degree of wear to be easily and accurately recognized.

### BRIEF DESCRIPTION OF THE DRAWINGS

FIG. 1 is a meridian cross-sectional view of a pneumatic tire according to an embodiment of the present technology.

FIG. 2 is a plan view of a tread surface of the pneumatic tire according to the embodiment of the present technology.

FIG. 3 is a cross-sectional perspective view taken along line A-A of FIG. 2.

FIG. 4 is a cross-sectional perspective view taken along line A-A of FIG. 2, illustrating another example.

FIG. 5 is a magnified perspective view of a recessed section.

FIG. 6 is a magnified perspective view of a recessed section.

FIG. 7 is a magnified perspective view of a recessed section.

FIG. 8 is a plan view illustrating another example of the tread surface of the pneumatic tire according to the embodiment of the present technology.

FIG. 9 is a cross-sectional perspective view taken along line B-B of FIG. 8.

FIG. 10 is a cross-sectional perspective view taken along line B-B of FIG. 10, illustrating another example.

FIG. 11 is a cross-sectional view indicating a recessed section.

FIG. 12 is a cross-sectional view indicating a recessed section.

FIGS. 13A-13B include a table showing results of performance testing of pneumatic tires according to working examples of the present technology.

FIGS. 14A-14B include a table showing results of performance testing of pneumatic tires according to working examples of the present technology.

FIGS. 15A-15B include a table showing results of performance testing of pneumatic tires according to working examples of the present technology.

FIGS. 16A-16B include a table showing results of performance testing of pneumatic tires according to working examples of the present technology.

### DETAILED DESCRIPTION

Embodiments of the present technology are described in detail below with reference to the accompanying drawings. However, no limitation of the present technology is intended by the embodiments. Furthermore, components of the embodiments include elements that may be easily replaced by those skilled in the art or that are substantially identical to components of the embodiments. Furthermore, a plurality of modified examples described in the embodiments may be combined as desired within the scope of obviousness by those skilled in the art.

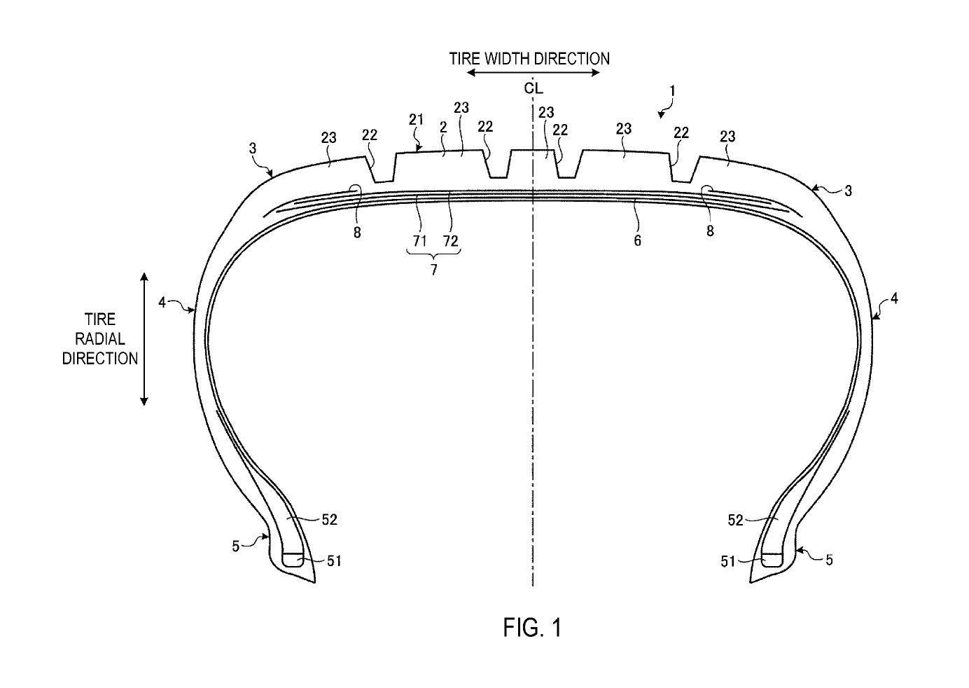

FIG. 1 is a meridian cross-sectional view of a pneumatic tire according to the present embodiment. In the following description, “tire radial direction” refers to a direction orthogonal to the rotational axis (not depicted) of the pneumatic tire 1. “Inner side in the tire radial direction” refers to a side facing the rotational axis in the tire radial direction, and “tire radial direction” refers to the side distanced from the rotational axis in the tire radial direction. Likewise, “tire circumferential direction” refers to a circumferential direction taking the rotational axis as a center axis. Additionally, “tire width direction” refers to a direction parallel to the rotational axis. “Inner side in the tire width direction” refers to a side facing a tire equatorial plane CL (tire equatorial line) in the tire width direction, and “outer side in the tire width direction” refers to a side distanced from the tire equatorial plane CL in the tire width direction. “Tire equatorial plane CL” refers to a plane that is orthogonal to the rotational axis of the pneumatic tire 1 and that passes through a center in the tire width direction of the pneumatic tire 1. The tire width is a width as measured in the tire width direction between components located on the outer side in the tire width direction, or in other words, the distance between components that are most distant, in the tire width direction, from the tire equatorial plane CL. “Tire equatorial line” refers to a line along the tire circumferential direction of the pneumatic tire 1 that lies on the tire equatorial plane CL. In the present embodiment, the tire equatorial line uses the same reference sign CL as the tire equatorial plane.

As illustrated in FIG. 1, the pneumatic tire 1 of the present embodiment includes a tread portion 2, shoulder portions 3 on both sides of the tread portion 2, and side wall portions 4 and bead portions 5 continuing sequentially from the respective shoulder portions 3. Additionally, the pneumatic tire 1 includes a carcass layer 6, a belt layer 7, and a belt reinforcing layer 8.

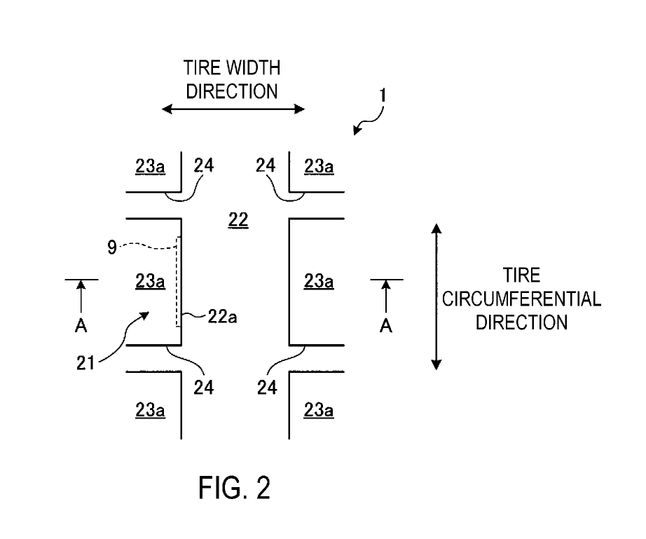

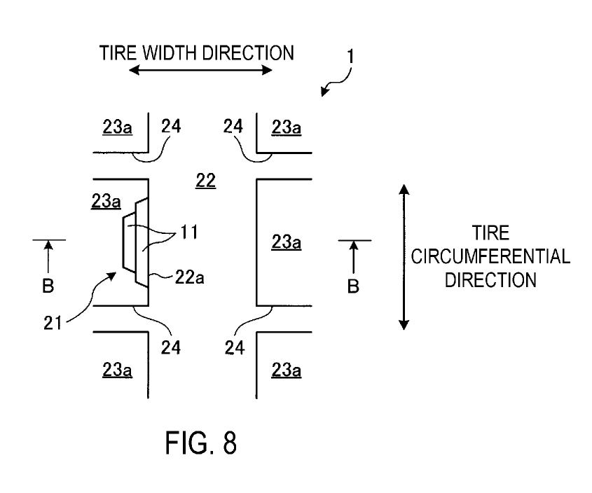

The tread portion 2 is formed from a rubber material (tread rubber) and is exposed on the outermost side in the tire radial direction of the pneumatic tire 1, such that a surface thereof constitutes a profile of the pneumatic tire 1. A tread surface 21 is formed on an outer peripheral surface of the tread portion 2 or, rather, on a road contact surface that comes in contact with a road surface during driving. The tread surface 21 has a plurality (four in the embodiments) of main grooves 22 provided therein, extending in the tire circumferential direction, the main grooves 22 being straight main grooves parallel to the tire equatorial line CL. Moreover, a plurality of rib-like land portions 23 extending in the tire circumferential direction and parallel to the tire equatorial line CL is formed in the tread surface 21 by the plurality of main grooves 22. Also, the rib-like land portions 23 in the tread surface 21 are provided with lug grooves 24 that intersect the main grooves 22, such that the land portions 23 are divided in plurality in the tire circumferential direction so as to form block-like land portions 23a (see FIG. 2 or FIG. 8).

The shoulder portions 3 are locations on both outer sides in the tire width direction of the tread portion 2. Additionally, the side wall portion 4 is exposed on the outermost side of the pneumatic tire 1 in the tire width direction. The bead portion 5 includes a bead core 51 and a bead filler 52. The bead core 51 is formed by winding a bead wire, which is a steel wire, into an annular shape. The bead filler 52 is a rubber material that is disposed in space formed by an end of the carcass layer 6 in the tire width direction being folded back at the position of the bead core 51.

The ends of the carcass layer 6 in the tire width direction are folded over the pair of bead cores 51 from the inner side in the tire width direction to the outer side in the tire width direction, and the carcass layer 6 is stretched in a toroidal shape in the tire circumferential direction to form the framework of the tire. The carcass layer 6 is constituted by a plurality of carcass cords (not illustrated) disposed parallel in the tire circumferential direction along a tire meridian direction at a given angle with respect to the tire circumferential direction and covered by a coating rubber. The carcass cords are formed from organic fibers (e.g., polyester, rayon, nylon, or the like). At least one layer of this carcass layer 6 is provided.

The belt layer 7 has a multi-layer structure in which at least two layers (belts 71 and 72) are laminated; is disposed on an outer side in the tire radial direction that is the periphery of the carcass layer 6, in the tread portion 2; and covers the carcass layer 6 in the tire circumferential direction. The belts 71 and 72 include a plurality of cords (not illustrated) disposed parallel at a predetermined angle with respect to the tire circumferential direction (e.g., from 20 degrees to 30 degrees), and covered by a coating rubber. The cords are formed from steel or organic fibers (e.g. polyester, rayon, nylon, or the like). Moreover, the belts 71 and 72 that overlap each other are disposed so that the respective cords intersect each other.

The belt reinforcing layer 8 is disposed on the outer side in the tire radial direction at the periphery of the belt layer 7, and covers the belt layer 7 in the tire circumferential direction. The belt reinforcing layer 8 includes a plurality of cords (not illustrated) disposed parallel in the tire width direction and substantially parallel (±5 degrees) to the tire circumferential direction, which are covered by a coating rubber. The cords are formed from steel or organic fibers (e.g. polyester, rayon, nylon, or the like). The belt reinforcing layer 8 illustrated in FIG. 1 is disposed so as to cover end portions of the belt layer 7 in the tire width direction. The configuration of the belt reinforcing layer 8 is not limited to that described above. Although not explicitly illustrated in the drawings, a configuration may be used in which the belt reinforcing layer 8 is disposed so as to cover the entirety of the belt layer 7. Alternatively, for example, a configuration having two reinforcing layers may be used, in which the belt reinforcing layer 8 is formed so that the reinforcing layer on the inner side in the tire radial direction is longer in the tire width direction than the belt layer 7 and is disposed so as to cover the entirety of the belt layer 7, and the reinforcing layer on the outer side in the tire radial direction is disposed so as only to cover the end portions of the belt layer 7 in the tire width direction. Alternatively, for example, a configuration having two reinforcing layers may be used, in which each of the reinforcing layers is disposed so as only to cover the end portions of the belt layer 7 in the tire width direction. In other words, the belt reinforcing layer 8 overlaps at least the end portions of the belt layer 7 in the tire width direction. Additionally, the belt reinforcing layer 8 is provided by winding band-like strip material (e.g. having a width of 10 mm) in the tire circumferential direction.

### Embodiment 1

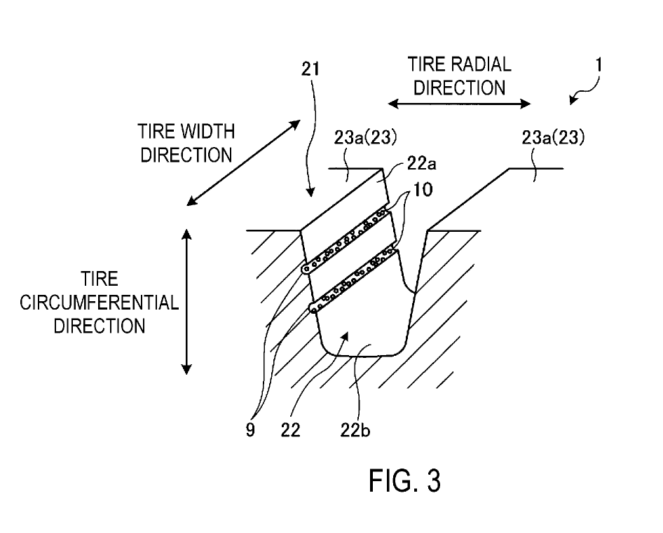

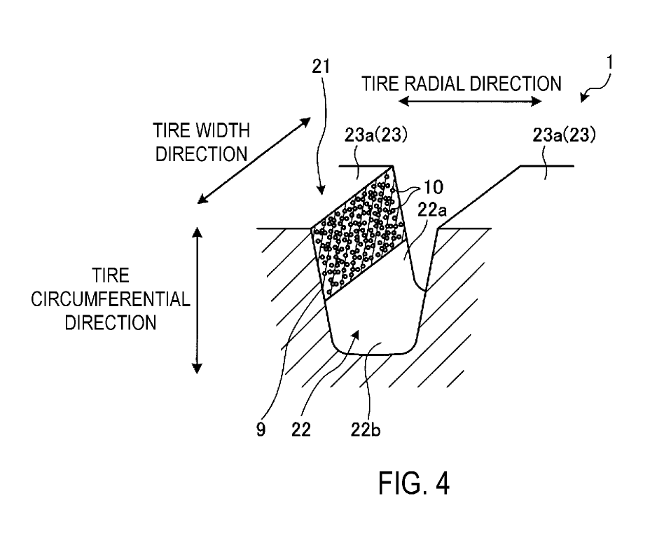

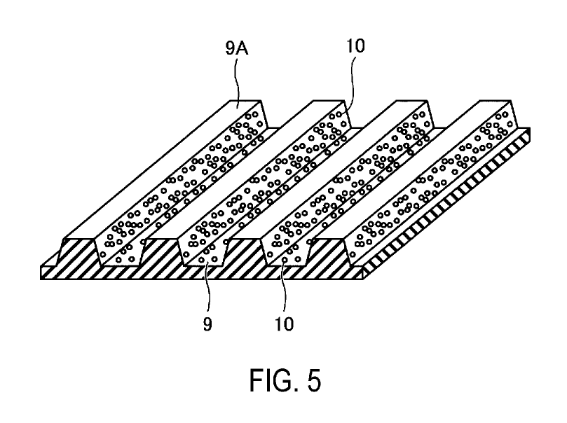

FIG. 2 is a plan view of a tread surface of a pneumatic tire according to the present embodiment. FIG. 3 is a cross-sectional perspective view taken along line A-A of FIG. 2. FIG. 4 is a cross-sectional perspective view taken along line A-A of FIG. 2, illustrating another example. FIGS. 5 to 7 are magnified perspective views each illustrating a recessed section of FIG. 4.

As illustrated in FIGS. 2 to 4, the pneumatic tire 1 of the present embodiment has a recessed section 9 formed in a groove wall surface 22a of a main groove 22. Furthermore, a photoluminescent material 10 adheres to the inside of the recessed section 9. Here, the groove wall surface 22a is a wall surface extending toward the outer side in the tire radial direction from a groove bottom 22b which is the deepest portion of the main groove 22, and reaching the tread surface 21.

The recessed section 9 illustrated in FIG. 3 is formed as a groove provided in the tire circumferential direction and sunk into the groove wall surface 22a of the main groove 22. Although not explicitly illustrated in the drawings, the recessed section 9 may also be formed as a groove provided between a pair of protrusions that are provided in the tire circumferential direction and protrude from the groove wall surface 22a of the main groove 22. Also, as illustrated in FIG. 3, the recessed section 9 is provided in plurality (e.g., two in FIG. 3) in the tire radial direction. However, any quantity may apply provided that at least one recessed section 9 is present. Furthermore, as illustrated in FIG. 3, the recessed section 9 is a groove having a semi-spherical cross section. However, the cross section of the groove may also be rectangular, triangular with a groove narrowing toward the bottom of the groove, trapezoidal with a groove narrowing toward the bottom of the groove, trapezoidal with a groove widening toward the bottom of the groove, or the like.

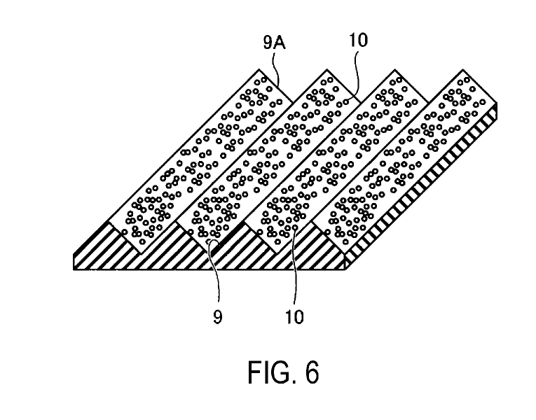

The recessed section 9 illustrated in FIG. 4 is formed as a groove provided in the spacing between a plurality of protrusions (ridges) 9A that are parallel and protrude from the groove wall surface 22a of the main groove 22, as illustrated in FIG. 5 and FIG. 6. Although not explicitly indicated in the drawings, the recessed section 9 may be provided in plurality so that the recessed sections 9 extend in parallel, each being a groove sunk into the groove wall surface 22a of the main groove 22. These recessed sections 9 may be formed so that protrusions (ridges) are formed between the recessed sections 9. Also, the recessed section 9 may be trapezoidal with a groove narrowing toward the bottom of the groove as illustrated in FIG. 5, may be triangular with the groove narrowing toward the bottom of the groove as illustrated in FIG. 6, or may be semi-spherical, rectangular, or trapezoidal with the groove widening toward the bottom of the groove as not explicitly illustrated in the drawings. Also, the recessed section 9 illustrated in FIG. 4 may be provided extending such that the protrusion 9A (recessed section 9) intersects the tire circumferential direction, may be provided in the tire circumferential direction, or may be provided in the tire radial direction.

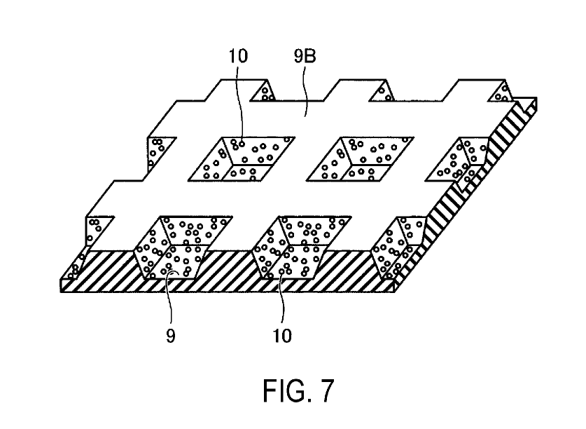

The recessed section 9 illustrated in FIG. 4 may also be formed as a dimple provided within a lattice-like projection 9B that projects from the groove wall surface 22a of the main groove 22, as illustrated in FIG. 7. Although not explicitly illustrated in the drawings, the recessed section 9 may also be provided as a plurality of recessed sections 9 each formed of a dimple sunk into the groove wall surface 22a of the main groove 22, such that the lattice-like projection 9B is formed between these recessed sections 9.

Also, the recessed section 9 illustrated in FIGS. 2 to 4 is provided in a part of the block-like land portion 23a in the tire circumferential direction. However, the recessed section 9 may also be provided across the entirety of the block-like land portion 23a in the tire circumferential direction. Furthermore, although not explicitly illustrated in the drawings, the recessed section 9 illustrated in FIGS. 2 to 4 may also be provided in a part of or across the entirety of the rib-like land portion 23.

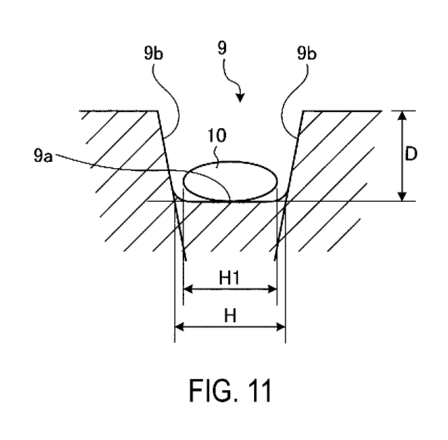

The photoluminescent material 10 adheres, to the inside of the recessed section 9, to an inner surface of the recessed section 9 (a bottom surface 9a or an inner side surface 9b: see FIG. 11). The photoluminescent material 10 is formed as a thin plate or as a scale-like small piece having a major axis of at least 50 μm and at most 1500 μm. The photoluminescent material 10, being such a small piece, easily conforms to deformations in the tire surface caused by rolling motion of the tire, and is thus unlikely to fall from the recessed section 9. The specific material used to form the photoluminescent material 10 may be polyethylene terephthalate (PET), aluminum, mica, talc, or the like. These materials have comparatively high photoluminescence.

Also, in FIGS. 2 to 4, the recessed section 9 is illustrated as being provided in the groove wall surface 22a on one side of the main groove 22. However, the recessed section 9 may also be provided in the groove wall surface 22a on both sides of the main groove 22. Also, in the above-described embodiment, the photoluminescent material 10 adheres to the inside of the recessed section 9 provided in the groove wall surface 22a of the main groove 22. However, the recessed section 9 may similarly be provided in a groove wall surface of the lug groove 24 and the photoluminescent material 10 may adhere to the inside of such a recessed section 9.

As such, the pneumatic tire 1 of the present embodiment is a pneumatic tire 1 having the main groove 22 (lug groove 24) in the tread surface 21. The recessed section 9 is provided in the groove wall surface 22a of the main groove 22 (lug groove 24), and the photoluminescent material 10 adheres to the inside of the recessed section 9.

According to this pneumatic tire 1, the photoluminescent material 10 adheres to the groove wall surface 22a of the main groove 22. Thus, a degree of wear of the tread surface 21 is recognizable by the photoluminescent material 10 decreasing or disappearing due to wear of the tread surface 21. Furthermore, according to this pneumatic tire 1, the photoluminescent material 10 adheres to the inside of the recessed section 9. Thus, even when a stone or the like enters the main groove 22 (lug groove 24), contact with the photoluminescent material 10 is prevented. As such, the photoluminescent material 10 may be prevented from falling, which also enables improvements to anti-abrasion characteristics and anti-weathering characteristics of the photoluminescent material 10. Therefore, the photoluminescence of the photoluminescent material 10 may be maintained while the degree of wear of the tread surface 21 is easily and accurately recognizable.

Here, as illustrated in FIG. 3, providing the recessed section 9 in plurality in the tire radial direction enables the degree of wear of the tread surface 21 to be clearly recognized as the photoluminescent material 10 (recessed section 9) is gradually reduced along with wear of the tread surface 21.

Also, as illustrated in FIG. 4, providing the recessed section 9 within a range of the tire radial direction enables the degree of wear of the tread surface 21 to be clearly confirmed as the photoluminescent material 10 (recessed section 9) is gradually reduced along with wear of the tread surface 21.

Furthermore, having the innermost portion in the tire radial direction of the recessed section 9 with the photoluminescent material 10 adhering thereto be the same in terms of height as the position of a wear indicator indicating a tire exchange period enables the exchange period to be recognized by the luminescence of the photoluminescent material 10 disappearing.

### Embodiment 2

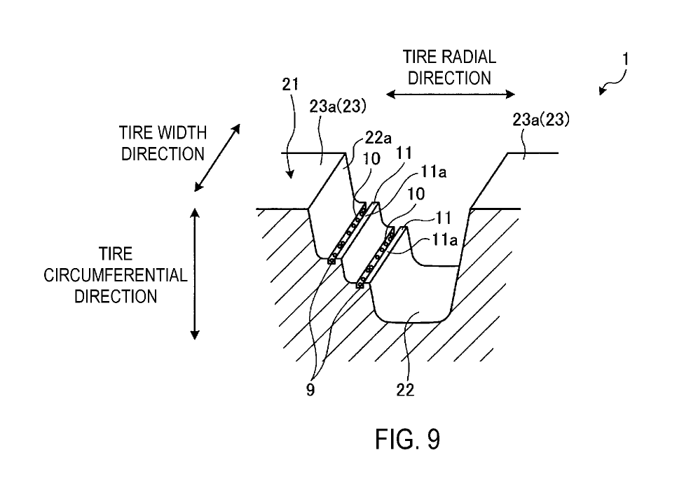

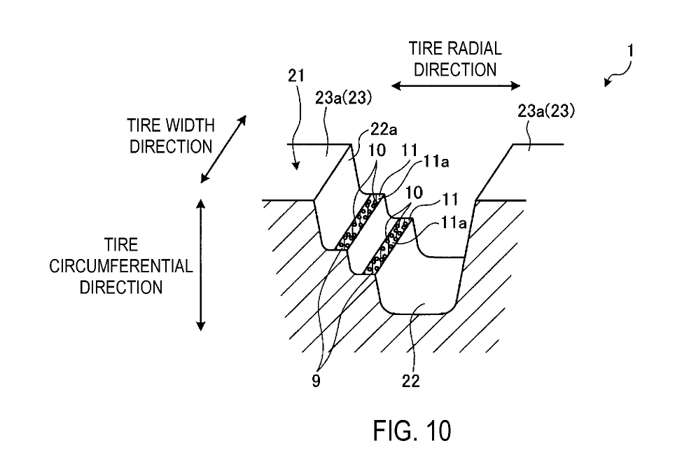

FIG. 8 is a plan view illustrating another example of the tread surface of the pneumatic tire according to the present embodiment. FIG. 9 is a cross-sectional perspective view taken along line B-B of FIG. 8. FIG. 10 is a cross-sectional perspective view taken along line B-B of FIG. 8, illustrating another example.

As illustrated in FIGS. 8 to 10, the pneumatic tire 1 of the present embodiment has a step 11 formed in a groove wall surface 22a of a main groove 22, and has a recessed section 9 formed in this step 11. Also, a photoluminescent material 10 adheres to the inside of the recessed section 9. In terms of the groove wall surface 22a of the main groove 22, the step 11 has a top surface 11a oriented toward the outer side in the tire radial direction. A side surface connected to this top surface 11a corresponds to the groove wall surface 22a of the main groove 22. As such, the top surface 11a and the side surface (groove wall surface 22a) are formed in the tire circumferential direction. Also, as illustrated in FIGS. 8 to 10, in a case in which the step 11 is formed in plurality in the tire radial direction, the side surface between the steps 11 is connected to the respective top surfaces 11a. Furthermore, the step 11 is provided in plurality in the tire radial direction in FIG. 9 (two in FIG. 9). However, any quantity may apply provided that at least one step 11 is provided.

The recessed section 9 provided in the step 11 illustrated in FIG. 9 is formed as a groove provided in the tire circumferential direction and sunk in from the top surface 11a of the step 11. Although not explicitly illustrated in the drawings, the recessed section 9 may also be formed as a groove provided between a pair of protrusions that are provided in the tire circumferential direction, protruding from the top surface 11a of the step 11. In addition, the recessed section 9 is formed with the groove having a rectangular cross-section as illustrated in FIG. 9. However, the groove may also have a semi-spherical cross-section, triangular cross-section with a groove narrowing toward the bottom of the groove, trapezoidal cross-section with a groove narrowing toward the bottom of the groove, trapezoidal cross-section with a groove widening toward the bottom of the groove, or the like.

The recessed section 9 provided in the step 11 illustrated in FIG. 10 is formed as a groove provided between a plurality of protrusions (ridges) 9A that are parallel to each other and protrude from the top surface 11a of the step 11, as illustrated in FIG. 5 and FIG. 6. Although not explicitly illustrated in the drawings, the recessed section 9 may also be provided as a plurality of recessed sections 9 each formed as a groove sunk in from the top surface 11a of the step 11, extending in parallel to each other such that a protrusion (ridge) is formed between the recessed sections 9. Also, the recessed section 9 may be trapezoidal with a groove narrowing toward the bottom of the groove as illustrated in FIG. 5, may be triangular with a groove narrowing toward the bottom of the groove as illustrated in FIG. 6, or may be semi-spherical, rectangular, or trapezoidal with a groove widening toward the bottom of the groove as not explicitly illustrated in the drawings. Furthermore, the recessed section 9 provided in the step 11 illustrated in FIG. 10 may be provided extending such that a protrusion 9A (recessed section 9) intersects the tire circumferential direction, may be provided in the tire circumferential direction, or may be provided in the tire width direction.

The recessed section 9 provided in the step 11 illustrated in FIG. 10 may also be formed as a dimple provided within a lattice-like projection 9B that projects from the groove wall surface 22a of the main groove 22, as illustrated in FIG. 7. Although not explicitly illustrated in the drawings, the recessed section 9 may also be provided as a plurality of recessed sections 9 each formed of a dimple sunk into the groove wall surface 22a of the main groove 22, such that the lattice-like projection 9B is formed between the recessed sections 9.

Here, the step 11 and the recessed section 9 illustrated in FIGS. 8 to 10 are provided in a part of the block-like land portion 23a in the tire circumferential direction. However, the step 11 and the recessed section 9 may also be provided across the entirety of the block-like land portion 23a in the tire circumferential direction. Furthermore, although not explicitly illustrated in the drawings, the step 11 and the recessed section 9 illustrated in FIGS. 8 to 10 may also be provided in a part of or across the entirety of the rib-like land portion 23 in the tire circumferential direction.

The photoluminescent material 10 adheres, to the inside of the recessed section 9, to an inner surface of the recessed section 9 (a bottom surface 9a or an inner side surface 9b: see FIG. 11). The photoluminescent material 10 is formed as a thin plate or as a scale-like small piece having a major axis of at least 50 μm and at most 1500 μm. The photoluminescent material 10, being such a small piece, easily conforms to deformations in the tire surface caused by rolling motion of the tire, and is thus unlikely to fall from the recessed section 9. The specific material used to form the photoluminescent material 10 may be polyethylene terephthalate (PET), aluminum, mica, talc, or the like. These materials have comparatively high photoluminescence.

Also, in FIGS. 8 to 10, the step 11 and the recessed section 9 are illustrated as being provided in the groove wall surface 22a on one side of the main groove 22. However, the step 11 and the recessed section 9 may also be provided in the groove wall surfaces 22a on both sides of the main groove 22. Also, in the above-described embodiment, the photoluminescent material 10 adheres to the inside of the recessed section 9 of the step 11 provided in the groove wall surface 22a of the main groove 22. However, the step 11 and the recessed section 9 may similarly be provided in a groove wall surface of a lug groove 24 and the photoluminescent material 10 may adhere to the inside of such a recessed section 9. Furthermore, in FIGS. 9 and 10, the recessed section 9 is provided in the top surface 11a of the step 11, and the photoluminescent material 10 is illustrated as adhering to the inside of this recessed section 9. However, the recessed section 9 may also be provided in a side surface of the step 11 (corresponding to the groove wall surface 22a) similarly to embodiment 1, and the photoluminescent material 10 adheres to the inside of the recessed section 9.

As such, the pneumatic tire 1 of the present embodiment is a pneumatic tire 1 having a main groove 22 (lug groove 24) in a tread surface 21. A recessed section 9 is provided in the groove wall surface 22a of the main groove 22 (lug groove 24), and a photoluminescent material 10 adheres to the inside of the recessed section 9.

According to this pneumatic tire 1, the photoluminescent material 10 adheres to the groove wall surface 22a of the main groove 22. Thus, a degree of wear of the tread surface 21 is recognizable by the photoluminescent material 10 decreasing or disappearing due to wear of the tread surface 21. Furthermore, according to this pneumatic tire 1, the photoluminescent material 10 adheres to the inside of the recessed section 9. Thus, even when a stone or the like enters the main groove 22 (lug groove 24), contact with the photoluminescent material 10 is prevented. As such, the photoluminescent material 10 may be prevented from falling, which also enables improvements to anti-abrasion characteristics and anti-weathering characteristics of the photoluminescent material 10. Therefore, the photoluminescence of the photoluminescent material 10 may be maintained while the degree of wear of the tread surface 21 is easily and accurately recognizable.

Furthermore, the pneumatic tire 1 of the present embodiment has the step 11 formed in the groove wall surface 22a of the main groove 22 (lug groove 24) in the tire circumferential direction. The recessed section 9 is provided at least in the top surface 11a forming the step 11, and the photoluminescent material 10 adheres to the inside of the recessed section 9.

According to this pneumatic tire 1, having the photoluminescent material 10 adhere to the inside of the recessed section 9 provided at least in the top surface 11a of the step 11 enables the visibility of the tread surface 21 to be improved in a plan view, thereby enabling a degree of wear of the tread surface 21 to be easily and accurately recognized.

Here, having the position in the tire radial direction of the step 11 (top surface 11a) having the recessed section 9 with the photoluminescent material 10 adhering thereto to be the same in terms of height as the position of a wear indicator indicating a tire exchange period enables the exchange period to be recognized by the luminescence of the photoluminescent material 10 disappearing.

Also, it is preferable that the pneumatic tire 1 of the present embodiment have the step 11 provided in plurality in the tire radial direction, have the recessed section 9 provided at least in the top surface 11a of each such step 11, and have the photoluminescent material 10 adhere to the inside of the recessed section 9.

According to this pneumatic tire 1, having the photoluminescent material 10 adhere to the inside of the recessed section 9 provided at least in the top surface 11a of each of the plurality of steps 11 enables the visibility of the tread surface 21 to be improved in a plan view, thereby enabling a degree of wear of the tread surface 21 to be easily and accurately recognized and further enabling the degree of wear of the tread surface 21 to be gradually recognized.

Also, in a case in which the step 11 is provided in plurality, the color of the photoluminescent material 10 may vary for each of the steps 11, thus enabling a gradual degree of wear of the tread surface 21 to be easily and accurately recognized. Here, having the innermost step 11 in the tire radial direction, among the plurality of steps 11 (top surfaces 11a) each having the recessed section 9 with the photoluminescent material 10 adhering thereto disposed at a position having the same height as that of a wear indicator indicating a tire exchange period enables the exchange period to be recognized by the luminescence of the photoluminescent material 10 disappearing.

### Embodiment 3

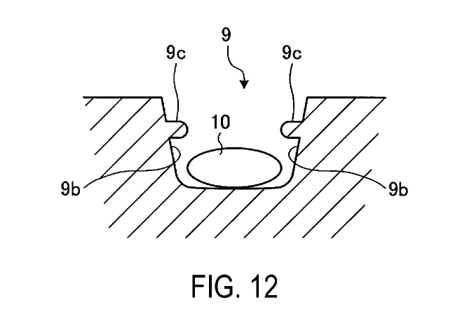

FIG. 11 and FIG. 12 are cross-sectional views each illustrating a recessed section. In embodiment 1 and embodiment 2, described above, it is preferable that the recessed section 9 have a range for a ratio of the major axis H1 of the photoluminescent material 10 to a width H of the bottom surface of the recessed 9 such that 0.3≦H1/H≦0.95, as illustrated in FIG. 11.

The width H of the bottom surface of the recessed section 9 is found by taking the deepest portion of the recessed section 9 as the bottom surface 9a, as illustrated in FIG. 11, drawing a reference line from the bottom surface 9a parallel to a surface provided in the recessed section 9 (i.e., the groove wall surface 22a or the top surface 11a of the step 11), and taking the distance between intersections made by the reference line intersecting another reference line drawn along the inner side surface 9b of the recessed section 9 toward the bottom surface 9a.

According to this pneumatic tire 1, the visibility of the photoluminescent material 10 is improved by having H1/H be at least 0.3. Also, having H1/H be no more than 0.95 enables the photoluminescent material 10 to fit well within the recessed section 9 and prevents the photoluminescent material 10 from falling out.

Furthermore, in embodiment 1 and embodiment 2 as described above, as illustrated in FIG. 11, a depth D of the recessed section 9 is preferably such that 0.2 mm≦D≦1.5 mm.

According to this pneumatic tire 1, having the depth D of the recessed section 9 be at least 0.2 mm enables the photoluminescent material 10 to fit well within the recessed section 9 and prevents the photoluminescent material 10 from falling out. Also, having the depth D of the recessed section 9 be no more than 1.5 mm enables the visibility of the photoluminescent material 10 to be improved.

In addition, in embodiment 1 and embodiment 2 described above, as illustrated in FIG. 12, a small projection 9c projecting from within the recessed section 9 is preferably provided on the inner side surface 9b, closer to an opening side than the bottom surface 9a of the recessed section 9. The small projection 9c may be provided on both of the inner side surfaces 9b facing each other as illustrated by FIG. 12, or may be provided on only one of the inner side surfaces 9b. Furthermore, the small projection 9c is not particular limited in terms of cross-sectional shape. The small projection 9c may continuously extend or discontinuously extend in an extension direction of the recessed section 9.

According to this pneumatic tire 1, as illustrated by FIG. 12, the photoluminescent material 10 adhering to the bottom surface 9a of the recessed section 9 engages with the small projection 9c, thus preventing the photoluminescent material 10 from falling out. A projection height of the small projection 9c relative to the inner side surface 9b of the recessed section 9 is preferably no more than 1.5 mm, for considerations of visibility for the photoluminescent material 10.

### Embodiment 4

In manufacturing the pneumatic tire 1 according to any one of embodiment 1 to embodiment 3, the photoluminescent material 10 is made to adhere to the inside of the recessed section 9 after vulcanization of the pneumatic tire 1 having the recessed section 9. Accordingly, the above-described pneumatic tire 1 may be obtained.

According to this manufacturing method for the pneumatic tire 1, the photoluminescent material 10 is pressure-bonded onto an inner surface (i.e., the bottom surface 9a or the inner side surface 9b) of the recessed section 9 by a solid body. Accordingly, this enables good adhesion for the photoluminescent material 10. Here, the solid body may have a shape conforming to the inner surface shape of the recessed section 9 in order to ensure close contact with the inner surface of the recessed section 9. For example, in a case in which the recessed section 9 is formed of a groove, using a disc-like roller that conforms to the groove enables the pressure-bonding work to be performed simply.

Also, according to the above-described manufacturing method for the pneumatic tire 1, a buffing process may be applied to the surface where the recessed section 9 is provided (i.e., the groove wall surface 22a or the top surface 11a of the step 11) upon adhesion of the photoluminescent material 10 to the inner surface of the recessed section 9, such that any excess of the photoluminescent material 10 adhering to a position outside the recessed section 9 (i.e., the groove wall surface 22a or the top surface 11a of the step 11) may be removed. That is, given that the photoluminescent material 10 adhering to the position outside the recessed section 9 is easy to remove, removing such excess in advance enables a stable state to be ensured for the photoluminescent material 10 in the long term. Also, external appearance may be improved in cases in which the photoluminescent material 10 adhering to the position outside the recessed section 9 is removed.

According to the present embodiment, the photoluminescent material 10 is required to adhere to the inside of the recessed section 9. However, more specifically, the photoluminescent material 10 preferably sticks inside the recessed section 9. For example, the photoluminescent material 10 may be mixed with an adhesive having adhesive properties in liquid form or in gel form. This enables the adhesive that includes the photoluminescent material 10 to be applied to the recessed section 9. Alternatively, an adhesive may be applied to the recessed section 9 in advance. This enables the photoluminescent material 10 to adhere superposed on the adhesive.

### WORKING EXAMPLES

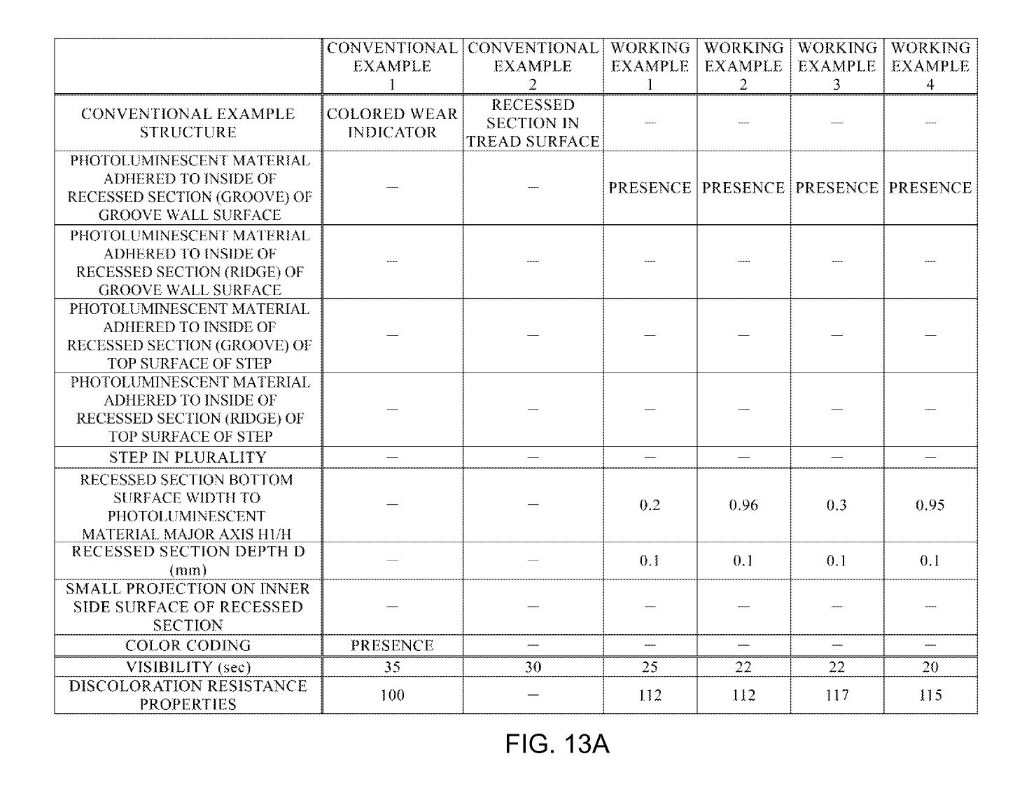

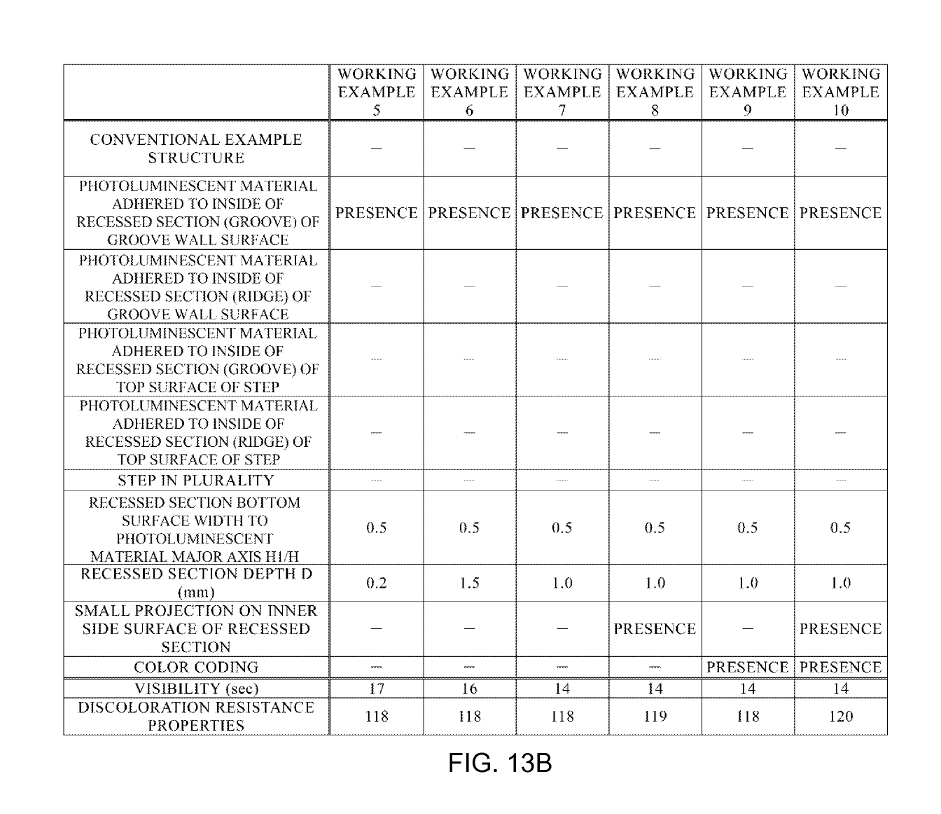

In these working examples, a variety of pneumatic tires under different conditions were used in performance testing pertaining to visibility and discoloration resistance properties (see FIGS. 13A to 16B).

In the performance testing, pneumatic tires having a tire size of 195/65R15 were assembled on a regular rim (15×6J), inflated to a regular inner pressure (230 kPa), and mounted on a test vehicle (1.4 L, front-wheel-drive vehicle, manufactured in Japan).

Here, “regular rim” refers to a “standard rim” defined by the Japan Automobile Tyre Manufacturers Association Inc. (JATMA), “Design Rim” defined by the Tire and Rim Association, Inc. (TRA), or “Measuring Rim” defined by the European Tyre and Rim Technical Organisation (ETRTO). Furthermore, “regular inner pressure” refers to “maximum air pressure” defined by JATMA, a maximum value described in “TIRE LOAD LIMITS AT VARIOUS COLD INFLATION PRESSURES” defined by TRA, or “INFLATION PRESSURES” defined by ETRTO.

The evaluation method for the visibility involves driving the above-described test vehicle on a dry road surface for 1000 km, then having each of ten panelists visually confirm wear conditions of the tread surface, and measuring the time required to confirm the wear conditions. The average time of the measurement results is evaluated. In this evaluation, a shorter time corresponds to preferable higher visibility.

The evaluation method for the discoloration resistance properties involves driving the above-described test vehicle on a dry road surface for 1000 km, then having each of ten panelists visually confirm the wear conditions of the tread surface, taking an average evaluation as an evaluation grade, and taking an index value in which conventional example 1 serves as a standard (100). In this evaluation a greater index corresponds to preferable maintained visibility, and high discoloration resistance properties.

In FIGS. 13A to 16B, the pneumatic tire of conventional example 1 has a colored wear indicator (see Japanese Unexamined Patent Application Publication No. H8-258517A). Also, the pneumatic tire of conventional example 2 has a plurality of recessed sections varying in depth, each separately disposed in a predetermined row direction in depth order (see Japanese Unexamined Patent Application Publication No. 2006-232152A).

In FIGS. 13A-13B, the pneumatic tires of working example 1 to working example 10 each have the photoluminescent material adhere to the inside of a recessed section (groove) provided in the groove wall surface of a main groove (see FIG. 3). The pneumatic tires of working example 1 to working example 8 each have the recessed section provided singularly. The pneumatic tires of working example 9 and working example 10 each have the recessed section provided in plurality (two) in the tire radial direction. The pneumatic tires of working example 3 to working example 10 each have a ratio between the width H of the bottom surface of the recessed section and the major axis H1 of the photoluminescent material such that within the defined range. The pneumatic tires of working example 5 to working example 10 each have a depth D of the recessed section such that within the defined range. The pneumatic tires of working example 8 and working example 10 are each provided with a small projection on the inner side surface of the recessed section. The pneumatic tires of working example 9 and working example 10 have different colors of the photoluminescent material adhere to the respective recessed sections.

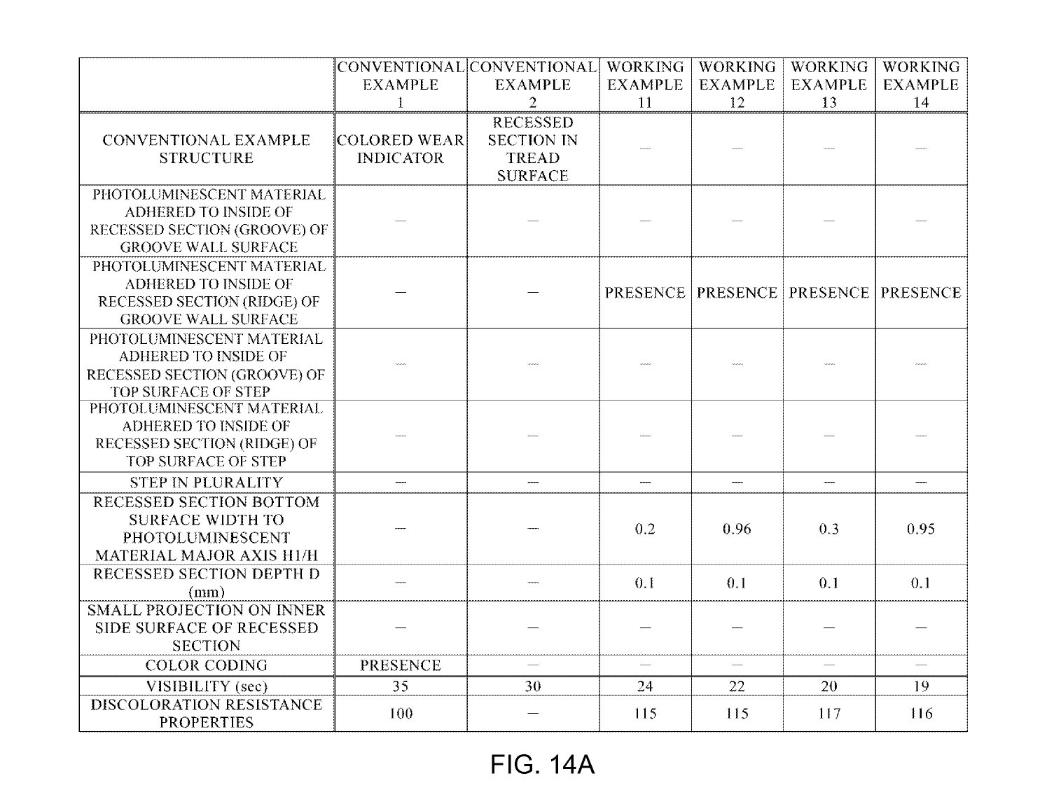

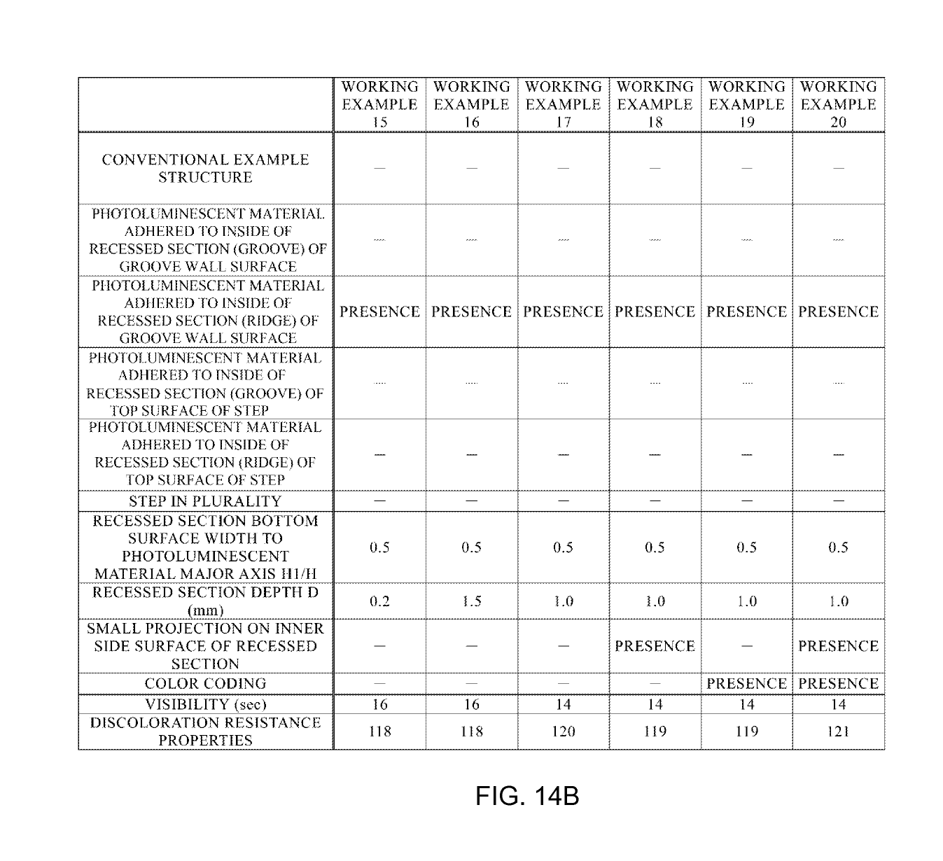

In FIGS. 14A-14B, the pneumatic tires of working example 11 to working example 20 each have the photoluminescent material adhere to the inside of a recessed section (ridge) provided in the groove wall surface of the main groove (see FIG. 4). The pneumatic tires of working example 13 to working example 20 each have a ratio between the width H of the bottom surface of the recessed section and the major axis H1 of the photoluminescent material within the defined range. The pneumatic tires of working example 15 to working example 20 each have the depth D of the recessed section within the defined range. The pneumatic tires of working example 18 and working example 20 are each provided with a small projection on the inner side surface of the recessed section. The pneumatic tires of working example 19 and working example 20 each have photoluminescent material adhered thereto, the photoluminescent material having different colors in the tire radial direction.

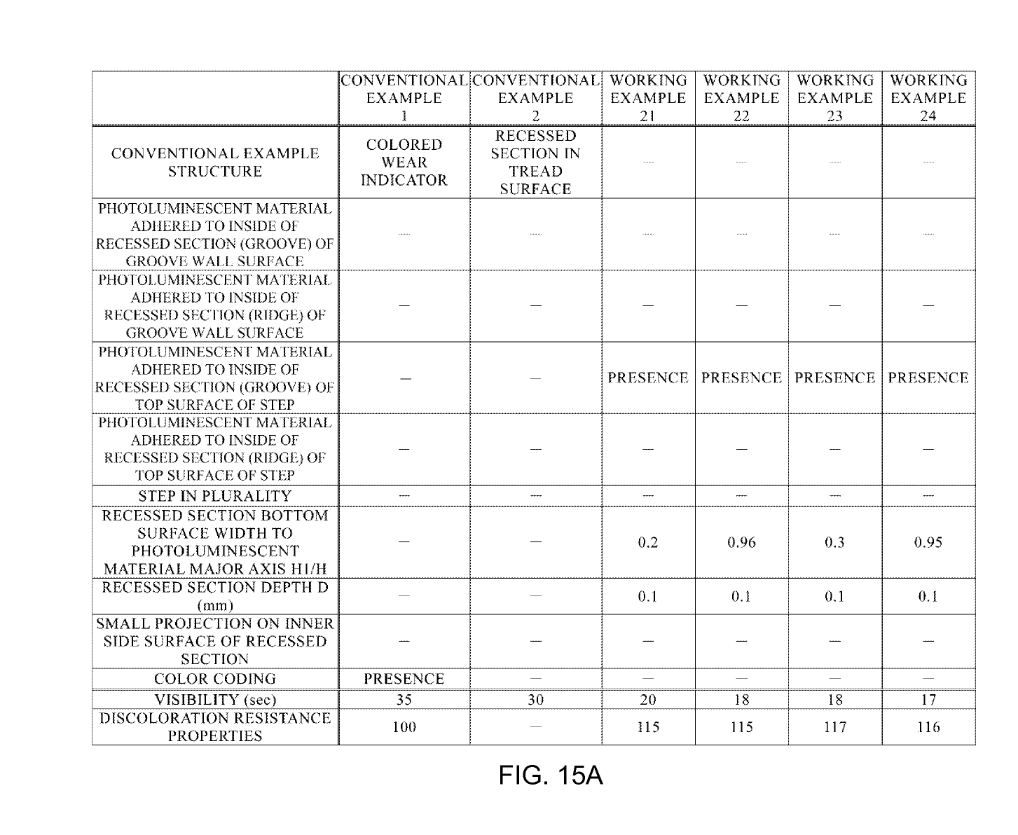

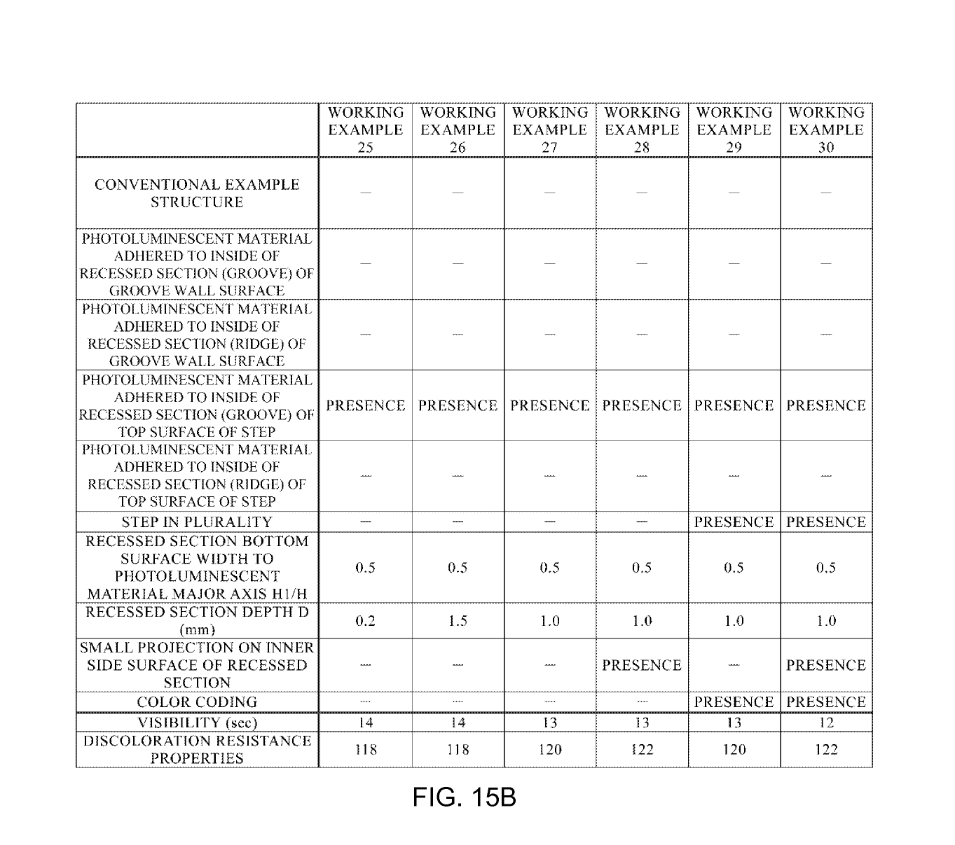

In FIGS. 15A-15B, the pneumatic tires of working example 21 to working example 30 each have the photoluminescent material adhered to the inside of a recessed section (groove) provided in the step top surface of a groove wall surface of a main groove (see FIG. 9). The pneumatic tires of working example 23 to working example 30 each have a ratio between the width H of the bottom surface of the recessed section and the major axis H1 of the photoluminescent material such that within the defined range. The pneumatic tires of working example 25 to working example 30 each have the depth D of the recessed section such that within the defined range. The pneumatic tires of working example 28 and working example 30 are each provided with a small projection on the inner side surface of the recessed section. The pneumatic tires of working example 29 and working example 30 each have the step provided in plurality (two) in the tire radial direction, and have a different color of the photoluminescent material adhered to the recessed section in each step.

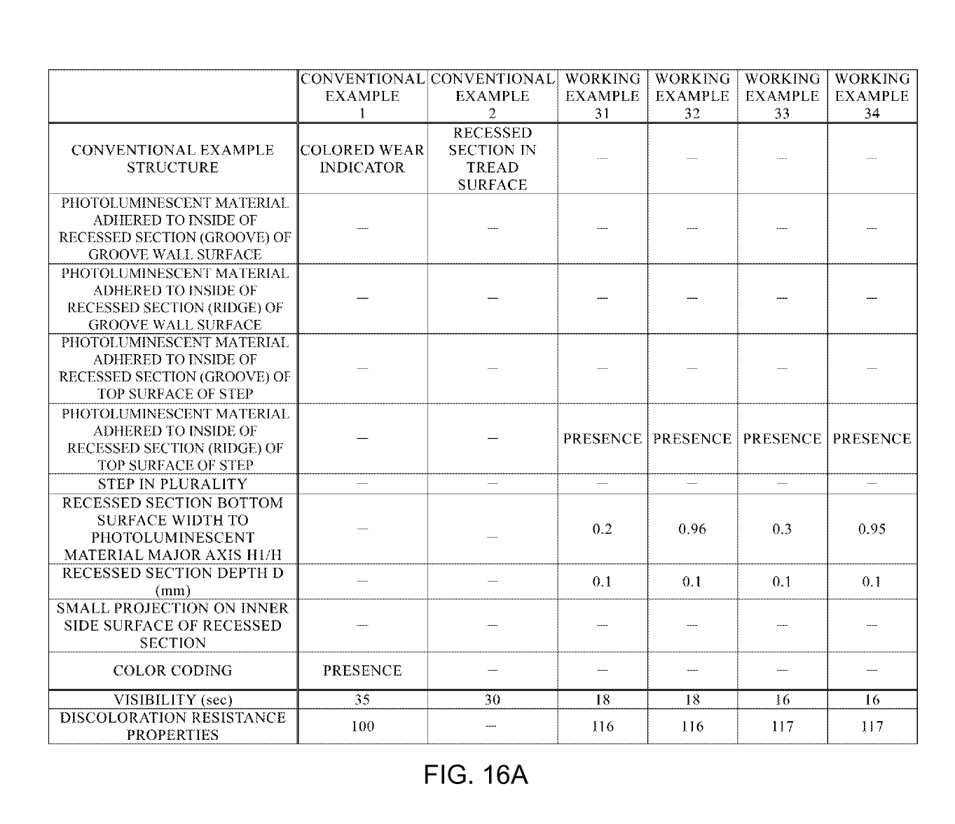

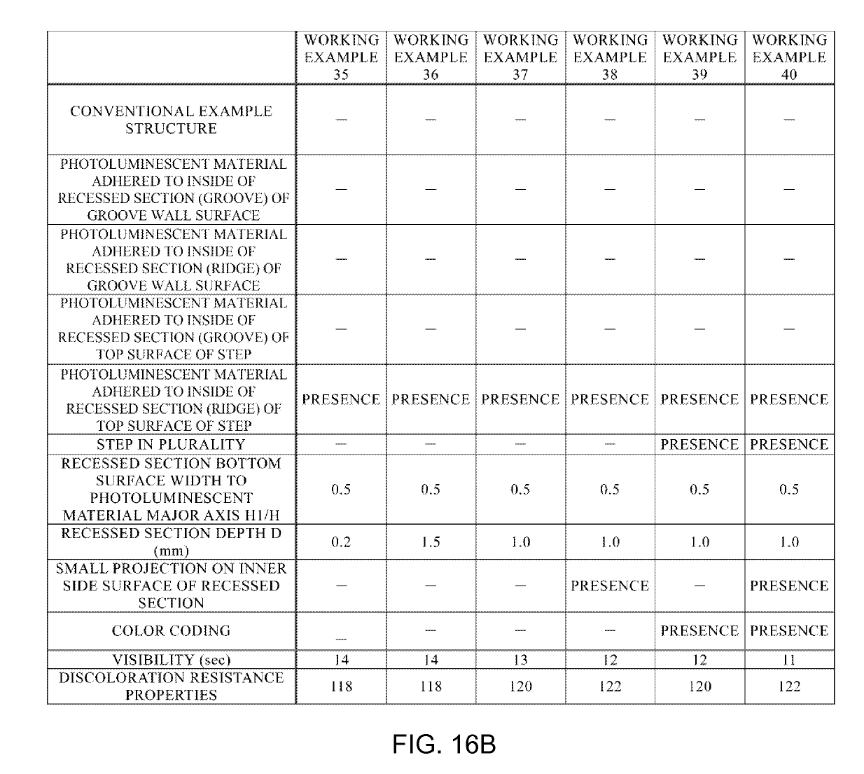

In FIGS. 16A-16B the pneumatic tires of working example 31 to working example 40 each have the photoluminescent material adhered to the inside of a recessed section (ridge) provided in the step top surface of a groove wall surface of a main groove (see FIG. 10). The pneumatic tires of working example 33 to working example 40 each have a ratio between the width H of the bottom surface of the recessed section and the major axis H1 of the photoluminescent material such that within the defined range. The pneumatic tires of working example 35 to working example 40 each have the depth D of the recessed section within the defined range. The pneumatic tires of working example 38 and working example 40 are each provided with a small projection on the inner side surface of the recessed section. The pneumatic tires of working example 39 and working example 40 each have the step provided in plurality (two) in the tire radial direction, and have a different color of the photoluminescent material adhered to the recessed section in each step.

As shown by the evaluation results in FIGS. 13A to 16B, the pneumatic tires of working example 1 to working example 40 each provide improvements to visibility and discoloration resistance properties, and enable the degree of wear to be easily and accurately recognizable.

1. A pneumatic tire with a groove in a tread surface, comprising:
a recessed section provided in a groove wall surface of the groove; and
a photoluminescent material adhered to an inside of the recessed section.

2. The pneumatic tire according to claim 1, wherein
a step is formed in the groove wall surface of the groove in a tire circumferential direction, the recessed section is provided at least in a top surface forming the step, and the photoluminescent material is adhered to the inside of the recessed section.

3. The pneumatic tire according to claim 2, wherein
the step is provided in plurality in a tire radial direction, the recessed section is provided at least in a top surface forming each of the steps, and the photoluminescent material is adhered to the inside of the recessed section.

4. The pneumatic tire according to 1, wherein
a ratio of a major axis H1 of the photoluminescent material to a width H of a bottom surface of the recessed section is such that 0.3≦H1/H≦0.95.

5. The pneumatic tire according to 1, wherein
a depth D of the recessed section is such that 0.2 mm≦D≦1.5 mm.

6. The pneumatic tire according to 1, wherein
a small projection projecting within the recessed section is provided on an inner side surface, closer to an opening side than to a bottom surface of the recessed section.

7. The pneumatic tire according to claim 2, wherein
a ratio of a major axis H1 of the photoluminescent material to a width H of a bottom surface of the recessed section is such that 0.3≦H1/H≦0.95.

8. The pneumatic tire according to claim 7, wherein
a depth D of the recessed section is such that 0.2 mm≦D≦1.5 mm.

9. The pneumatic tire according to claim 8, wherein
a small projection projecting within the recessed section is provided on an inner side surface, closer to an opening side than to the bottom surface of the recessed section.

10. The pneumatic tire according to claim 7, wherein
a small projection projecting within the recessed section is provided on an inner side surface, closer to an opening side than to the bottom surface of the recessed section.

11. The pneumatic tire according to claim 5, wherein
a small projection projecting within the recessed section is provided on an inner side surface, closer to an opening side than to a bottom surface of the recessed section.

12. The pneumatic tire according to claim 4, wherein
a small projection projecting within the recessed section is provided on an inner side surface, closer to an opening side than to the bottom surface of the recessed section.

13. The pneumatic tire according to claim 4, wherein
a depth D of the recessed section is such that 0.2 mm≦D≦1.5 mm.

14. The pneumatic tire according to claim 3, wherein
a ratio of a major axis H1 of the photoluminescent material to a width H of a bottom surface of the recessed section is such that 0.3≦H1/H≦0.95.

15. The pneumatic tire according to claim 14, wherein
a depth D of the recessed section is such that 0.2 mm≦D≦1.5 mm.

16. The pneumatic tire according to claim 15, wherein
a small projection projecting within the recessed section is provided on an inner side surface, closer to an opening side than to the bottom surface of the recessed section.

17. The pneumatic tire according to claim 3, wherein
a small projection projecting within the recessed section is provided on an inner side surface, closer to an opening side than to a bottom surface of the recessed section.

18. The pneumatic tire according to claim 3, wherein
a depth D of the recessed section is such that 0.2 mm≦D≦1.5 mm.

19. The pneumatic tire according to claim 2, wherein
a small projection projecting within the recessed section is provided on an inner side surface, closer to an opening side than to a bottom surface of the recessed section.

20. The pneumatic tire according to claim 2, wherein
a depth D of the recessed section is such that 0.2 mm≦D≦1.5 mm.
